(19) United States
(12) Patent Application Publication
(10) Pub. No.: US 2025/0219789 A1
(43) Pub. Date: Jul. 3, 2025

(54) CONFIGURING MULTIPLE CSI REPORTING SETTINGS

(71) Applicant: Lenovo (United States) Inc., Morrisville, NC (US)

(72) Inventor: Ahmed Hindy, Aurora, IL (US)

(21) Appl. No.: 19/086,043

(22) Filed: Mar. 20, 2025

(51) Int. Cl. H04L 5/00; H04W 24/10

(52) U.S. Cl. CPC H04L 5/0051; H04W 24/10

(57) ABSTRACT

Various aspects of the present disclosure relate to receiving, from a network node, a first configuration including a first CSI resource configuration associated with a first set of channel measurement resources; receiving, from the network node, a second configuration including: a second CSI resource configuration associated with a second set of channel measurement resources and an identifier of the first configuration; performing a CSI measurement based on the first CSI resource configuration and the second CSI resource configuration, where the first configuration is received no later than the second configuration; generating a CSI report based on performing the CSI measurement; and transmitting, to the network node, the CSI report including one or more PMI values based on a codebook configuration.

### TECHNICAL FIELD

The present disclosure relates to wireless communications, and more specifically to techniques for configuring a device with two or more channel state information (CSI) reporting settings, e.g., for training and inference.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive, from a network node, a first configuration associated with a first CSI reporting setting including: a first report quantity corresponding to a first value, and a first CSI resource configuration associated with a first set of channel measurement resources; receive, from the network node, a second configuration associated with a second CSI reporting setting including: a second report quantity containing at least a precoding matrix indicator (PMI) value associated with a codebook configuration, a second CSI resource configuration associated with a second set of channel measurement resources, and an identifier of the first configuration; perform a CSI measurement based on the first CSI resource configuration and the second CSI resource configuration, wherein the first configuration is received no later than the second configuration; generate a CSI report based on performing the CSI measurement; and transmit, to the network node, the CSI report including one or more PMI values based on the codebook configuration.

A processor for wireless communication is described. In some examples, the processor may be implemented in a UE. The processor may be configured to, capable of, or operable to receive, from a network node, a first configuration associated with a first CSI reporting setting including: a first report quantity corresponding to a first value, and a first CSI resource configuration associated with a first set of channel measurement resources; receive, from the network node, a second configuration associated with a second CSI reporting setting including: a second report quantity containing at least a PMI value associated with a codebook configuration, a second CSI resource configuration associated with a second set of channel measurement resources, and an identifier of the first configuration; perform a CSI measurement based on the first CSI resource configuration and the second CSI resource configuration, wherein the first configuration is received no later than the second configuration; generate a CSI report based on performing the CSI measurement; and transmit, to the network node, the CSI report including one or more PMI values based on the codebook configuration.

A method performed or performable by a UE is described. The method may include receiving, from a network node, a first configuration associated with a first CSI reporting setting including: a first report quantity corresponding to a first value, and a first CSI resource configuration associated with a first set of channel measurement resources; receiving, from the network node, a second configuration associated with a second CSI reporting setting including: a second report quantity containing at least a PMI value associated with a codebook configuration, a second CSI resource configuration associated with a second set of channel measurement resources, and an identifier of the first configuration; performing a CSI measurement based on the first CSI resource configuration and the second CSI resource configuration, wherein the first configuration is received no later than the second configuration; generating a CSI report based on performing the CSI measurement; and transmitting, to the network node, the CSI report including one or more PMI values based on the codebook configuration.

A NE for wireless communication is described. In some examples, the NE may be implemented in a base station. The NE may be configured to, capable of, or operable to transmit, to a UE, a first configuration associated with a first CSI reporting setting including: a first report quantity corresponding to a first value, and a first CSI resource configuration associated with a first set of channel measurement resources; transmit, to the UE, a second configuration associated with a second CSI reporting setting including: a second report quantity containing at least a PMI value associated with a codebook configuration, a second CSI resource configuration associated with a second set of channel measurement resources, and an identifier of the first configuration; transmit a set of CSI reference signals (CSI-RS) associated with the first CSI resource configuration or the second CSI resource configuration, or both, wherein the first configuration is transmitted no later than the second configuration; and receive a CSI report from the UE, the CSI report including one or more PMI values based on the codebook configuration, the first configuration, and the second configuration.

A processor for wireless communication is described. In some examples, the processor may be implemented in a NE or a base station. The processor may be configured to, capable of, or operable to transmit, to a UE, a first configuration associated with a first CSI reporting setting including: a first report quantity corresponding to a first value, and a first CSI resource configuration associated with a first set of channel measurement resources; transmit, to the UE, a second configuration associated with a second CSI reporting setting including: a second report quantity containing at least a PMI value associated with a codebook configuration, a second CSI resource configuration associated with a second set of channel measurement resources, and an identifier of the first configuration; transmit a set of CSI-RS associated with the first CSI resource configuration or the second CSI resource configuration, or both, wherein the first configuration is transmitted no later than the second configuration; and receive a CSI report from the UE, the CSI report including one or more PMI values based on the codebook configuration, the first configuration, and the second configuration.

A method performed or performable by a NE is described. In some examples, the NE may be implemented in a base station. The method may include transmitting, to a UE, a first configuration associated with a first CSI reporting setting including: a first report quantity corresponding to a first value, and a first CSI resource configuration associated with a first set of channel measurement resources; transmitting, to the UE, a second configuration associated with a second CSI reporting setting including: a second report quantity containing at least a PMI value associated with a codebook configuration, a second CSI resource configuration associated with a second set of channel measurement resources, and an identifier of the first configuration; transmitting a set of CSI-RS associated with the first CSI resource configuration or the second CSI resource configuration, or both, wherein the first configuration is transmitted no later than the second configuration; and receiving a CSI report from the UE, the CSI report including one or more PMI values based on the codebook configuration, the first configuration, and the second configuration.

### BRIEF DESCRIPTION OF THE DRAWINGS

FIG. 1 illustrates an example of a wireless communications system in accordance with aspects of the present disclosure.

FIG. 2 illustrates an example of a protocol stack, in accordance with aspects of the present disclosure.

FIG. 3 illustrates an example of an aperiodic trigger state defining a list of CSI reporting settings, in accordance with aspects of the present disclosure.

FIG. 4A illustrates an example of an Abstract Syntax Notation One (ASN.1) structure of an aperiodic trigger state that indicates the resource set and quasi-co-location (QCL) information, in accordance with aspects of the present disclosure.

FIG. 4B illustrates an example of an ASN.1 structure of a CSI resource configuration associated with the aperiodic trigger state of FIG. 4A, in accordance with aspects of the present disclosure.

FIG. 5A illustrates an example of an ASN.1 structure of a radio resource control (RRC) configuration for NZP CSI-RS resources, in accordance with aspects of the present disclosure.

FIG. 5B illustrates an example of an ASN.1 structure of an RRC configuration for CSI for interference measurement (CSI-IM) resources, in accordance with aspects of the present disclosure.

FIG. 6A illustrates an example of CSI report generation, in accordance with aspects of the present disclosure.

FIG. 6B illustrates an example of partial CSI omission and reordering for physical uplink shared channel (PUSCH) based CSI, in accordance with aspects of the present disclosure.

FIG. 7 illustrates an example of a CSI reporting setting information element (IE), in accordance with aspects of the present disclosure.

FIG. 8 illustrates an example of a signaling timeline of CSI-RS for the data collection phase, in accordance with aspects of the present disclosure.

FIG. 9 illustrates an example of signaling timeline of CSI-RS for the channel inference phase, in accordance with aspects of the present disclosure.

FIG. 10 illustrates an example of a procedure for configuring a UE with multiple CSI reporting settings for AI/ML training and inference, in accordance with aspects of the present disclosure.

FIG. 11 illustrates another example of a procedure for configuring a UE with multiple CSI reporting settings for AI/ML training and inference, in accordance with aspects of the present disclosure.

FIG. 12 illustrates an example of a UE, in accordance with aspects of the present disclosure.

FIG. 13 illustrates an example of a processor, in accordance with aspects of the present disclosure.

FIG. 14 illustrates an example of a NE, in accordance with aspects of the present disclosure.

FIG. 15 illustrates a flowchart of a method performed by a UE, in accordance with aspects of the present disclosure.

FIG. 16 illustrates a flowchart of a method performed by an NE, in accordance with aspects of the present disclosure.

### DETAILED DESCRIPTION

Wireless communication systems beyond 5G may implement artificial intelligence (AI) and/or machine learning (ML) (collectively referred to as “AI/ML”) techniques to improve the accuracy of channel state information (CSI) corresponding to a channel between a device (e.g., UE) and a network node (e.g., base station or NE) particularly in environments with challenging radio conditions. One example of AI/ML enhanced channel estimation is the compression of CSI parameters in a CSI feedback report, where the output of the AI/ML model is the compressed CSI report. Another example of AI/ML enhanced channel estimation is the selection of a precoding matrix based on the CSI, where the output of the AI/ML model is the precoding matrix. Yet another example of AI/ML enhanced channel estimation is the selection of a beam from a codebook of beams, based on the CSI, where the output of the AI/ML model is the beam selection.

A trained AI/ML model may include a large number (e.g., thousands, tens of thousands, or hundreds of thousands) of parameters. Training the AI/ML model involves inputting data. Accordingly, transferring this large number of parameters to a wireless node (e.g., transferring to a base station or a UE over a wireless channel) may result in a significant expenditure of time and energy, and may consume a large amount of the wireless bandwidth and network resources. The task of transferring the parameters of an AI/ML model, such as a deep neural network (DNN) model, from one device (e.g., a first wireless node) to another device (e.g., a second wireless node) is commonly referred to as “model transfer.”

Aspects of the present disclosure describe techniques for AI/ML data collection for UE-sided model training, such as CSI prediction models. Beneficially, the techniques described herein allow for multiple configurations to match the UE's need for different phases of AI/ML model training. Additionally, or alternatively, the techniques for AI/ML data collection described herein allow for release of a collected dataset when an AI/ML model becomes unusable or obsolete.

A first solution describes a framework for configuring a UE with multiple, related CSI reporting settings corresponding to AI/ML model training phases or AI/ML model inference phases. In some examples, the UE is configured with a first CSI reporting setting corresponding to CSI measurement for data collection and/or training, and configured with a second CSI reporting setting corresponding to CSI measurement and reporting for the inference process. In certain examples, the two CSI reporting settings are explicitly associated with each other.

A second solution describes a framework for indicating appropriate QCL relationships across CSI-RS resources corresponding to the multiple, related CSI reporting settings (e.g., CSI-RS resources corresponding to the first CSI reporting setting and the second CSI reporting setting).

A third solution describes techniques for matching a burst configuration of aperiodic CSI-RS resources for inference (e.g. associated with the second CSI reporting setting) with a configuration of multiple periodic CSI-RS resources for data collection. In some examples, the matching is based on the first CSI reporting setting via aligning the time spacing between the triggered aperiodic CSI-RS resources and the offset values of the multiple periodic CSI-RS resources.

A fourth solution describes a framework for configuring the UE to release the collected dataset for channel measurement based on the second CSI reporting setting. For instance, the UE may release the collected dataset for channel measurement whenever the network determines the corresponding model is unusable or obsolete.

While presented as distinct solutions, one or more of the solutions described herein may be implemented in combination with each other. Aspects of the present disclosure are described in the context of a wireless communications system.

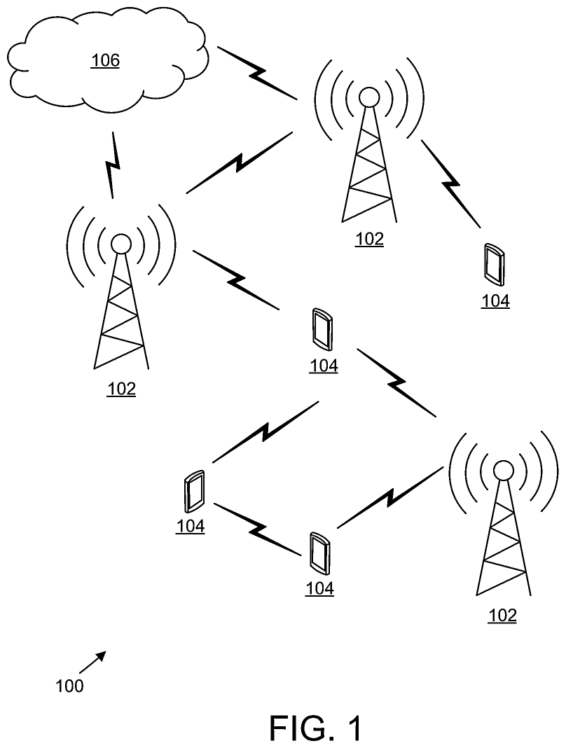

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 KHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, a respective UE 104 may receive, from an NE 102, a first CSI reporting setting including at least: A) a first report quantity corresponding to a first value (e.g., ‘none’); and B) a first CSI resource configuration associated with a first set of channel measurement resources.

The UE 104 may also receive, from the NE 102, a second CSI reporting setting including at least: A) a second report quantity that indicates at least a PMI value associated with a codebook configuration, B) a second CSI resource configuration associated with a second set of channel measurement resources, and C) an identifier of the first configuration.

The NE 102 transmits a set of CSI-RS associated with the first CSI resource configuration or the second CSI resource configuration, or both. In various implementations, the NE 102 transmits the second configuration to the UE 104 at the same time or before the transmission of the first configuration.

Based on the first CSI resource configuration and the second CSI resource configuration, the UE 104 performs one or more CSI measurements. The UE 104 generates at least one CSI report based on performing the CSI measurement(s) and transmits, to the NE 102, the CSI report including one or more PMI values based on the codebook configuration.

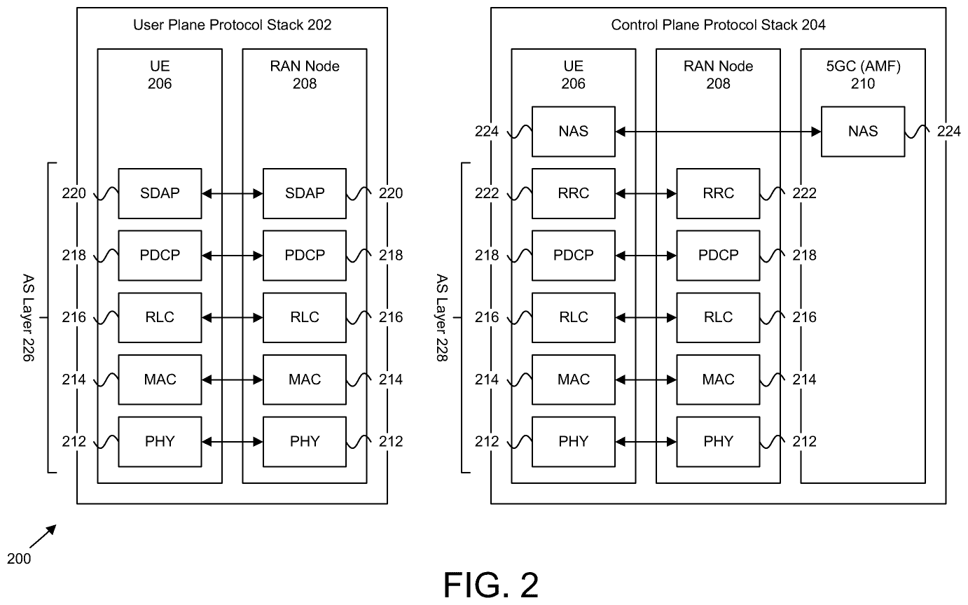

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a MAC sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, an RLC sublayer 216, and a PDCP sublayer 218. The Control Plane protocol stack 204 also includes a RRC layer 222 and a non-access stratum (NAS) layer 224.

The AS layer 226 (also referred to as “AS protocol stack”) for the user plane protocol stack 202 consists of at least the SDAP sublayer 220, the PDCP sublayer 218, the RLC sublayer 216, the MAC sublayer 214, and the PHY layer 212. The AS layer 228 for the control plane protocol stack 204 consists of at least the RRC layer 222, the PDCP sublayer 218, the RLC sublayer 216, the MAC sublayer 214, and the PHY layer 212. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels (LCHs) to the RLC sublayer 216. The RLC sublayer 216 offers RLC channels to the PDCP sublayer 218.

The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation (CA) and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through LCHs. The MAC sublayer 214 therefore performs multiplexing and demultiplexing between LCHs and transport channels: the MAC sublayer 214 in the transmitting side constructs MAC PDUs (also known as transport blocks (TBs)) from MAC service data units (SDUs) received through LCHs, and the MAC sublayer 214 in the receiving side recovers MAC SDUs from MAC PDUs received through transport channels.

The MAC sublayer 214 provides a data transfer service for the RLC sublayer 216 through LCHs, which are either control LCHs which carry control data (e.g., RRC signaling) or traffic LCHs which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. An LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also, the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

Regarding the 3GPP NR Release 15 (Rel-15) Type-II Codebook, it is assumed that the NE 102 (e.g., a gNB) is equipped with a two-dimensional (2D) antenna array with N₁, N₂ antenna ports per polarization placed, with N, being the horizontal dimension and N₂ being the vertical dimension of the array. In the frequency domain (FD), communication occurs over N₃ PMI subbands. A PMI subband consists of a set of resource blocks (RBs), each RB consisting of a set of subcarriers. Considering dual polarization, there are 2N₁N₂ CSI-RS ports which are utilized to enable DL channel estimation with high resolution for the NR Rel-15 Type-II codebook. Further details on NR codebook types can be found in 3GPP Technical Specification (TS) 38.214.

In order to reduce the UL feedback overhead, a discrete Fourier transform (DFT)-based transformation is used to project the channel onto L spatial beams (shared by both polarizations) where L<N₁N₂. In the following, the indices of the L dimensions are referred as the spatial domain (SD) basis indices. The magnitude and phase values of the 2L linear combination coefficients for each subband are fed back to the NE 102 as part of the CSI report. The 2N₁N₂×N₃ codebook per transmission layer/takes on the form:

$$W = {W}_{1} {W}_{2 , l}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} \\ {m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation. O₁, O₂ are oversampling factors, assumed for the 2D DFT matrix from which matrix B is drawn.

The matrix W₁ is common across all transmission layers. The matrix W_{2,l} is a 2L×N₃ matrix, where the i^{th} column corresponds to the linear combination coefficients of the 2L beams in the i^{th} subband. The indices of the L selected columns of B are reported, along with the oversampling index taking on O₁O₂ values. W_{2,l} are independent for different transmission layers.

Regarding 3GPP NR Rel-15, for Type-II port selection codebook, only K (where K≤2N₁N₂) beamformed CSI-RS ports are utilized in DL transmission, in order to reduce complexity. The K×N₃ codebook matrix per transmission layer l takes on the form:

$$W = {W}_{1}^{PS} {W}_{2 , l}$$

Here, the matrices W_{2,l} follow the same structure as the conventional NR Rel-15 Type-II codebook, and are transmission layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

and E is a k/2×L matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is a RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. The matrix W₁^{PS} is common across all transmission layers.

For K=16, L=4 and d_{PS}=1, the 8 possible realizations of E corresponding to m_{PS}={0,1, . . . ,7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0 \\ 1 & 0 & 0\end{matrix} \text{?}$$

$$\text{?} \text{indicates text missing or illegible when filed}$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for rank indicator (RI)=1,2, wherein a phase coupling value is reported for each subband, i.e., W_{2,l} is 2×N₃, with the first row equal to [1, 1, . . . , 1] and the second row equal to

$$[ {e}^{j 2 {π∅}_{0}} , … , {e}^{j 2 π {∅}_{{N}_{3} - 1}} ] .$$

Under specific configurations, ϕ₀=ϕ₁ . . . =ϕ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Release 16 (Rel-16) Type-II codebook, it is assumed that the NE 102 is equipped with a 2D antenna array with N₁, N₂ antenna ports per polarization placed, with N₁ being the horizontal dimension and N₂ being the vertical dimension of the array. In the FD, communication occurs over N₃ PMI subbands. A PMI subband consists of a set of RBs, each RB consisting of a set of subcarriers. Considering dual polarization, there are 2N₁N₂N₃ CSI-RS ports which are utilized to enable DL channel estimation with high resolution for NR Rel-16 Type-II codebook. In order to reduce the UL feedback overhead, a DFT-based transformation is used to project the channel onto L spatial beams (shared by both polarizations) where L<N₁N₂. Similarly, additional compression in the FD is applied, where each beam of the FD precoding vectors is transformed using an inverse DFT matrix to the delay domain, and the magnitude and phase values of a subset of the delay-domain coefficients are selected and fed back to the NE 102 as part of the CSI report.

The 2N₁N₂×N₃ codebook per transmission layer/takes on the form:

$$W = {W}_{1} {\tilde{W}}_{2 , l} {W}_{f , l}^{H}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π 1}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 2} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation, and the superscript ^{H} denotes a matrix Hermitian, i.e., conjugate transposition operator. O₁, O₂ oversampling factors are assumed for the 2D DFT matrix from which matrix B is drawn. W₁ is common across all transmission layers. In various embodiments, the above parameters comply with 3GPP TS 38.214 definitions and procedures.

Each matrix W_{f,l} is an N₃×M matrices (where M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T}$$

Only the indices of the L selected columns of B are reported, along with the oversampling index taking on O₁O₂ values. Similarly, for W_{f,l} ,only the indices of the M selected columns out of the predefined size-N₃ DFT matrix are reported. In the sequel the indices of the M dimensions are referred as the selected FD basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}_{2,l}, W_{f,l} are selected independently for different transmission layers.

Amplitude and phase values of an approximately β fraction of the 2LM available coefficients are reported to the NE 102 (β<1) as part of the CSI report. One or more coefficients with zero magnitude are indicated via a per-layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of ┌2βLM┐−1 coefficients (along with the indices of selected L, M DFT vectors) are reported per transmission layer, leading to significant reduction in CSI report size, compared with reporting 2N₁N₂×N₃−1 coefficients' information of a theoretical design.

Regarding 3GPP NR Rel-16, for Type-II port selection codebook, only K (where K≤2N₁N₂) beamformed CSI-RS ports are utilized in DL transmission, in order to reduce complexity. The K×N₃ codebook matrix per transmission layer l takes on the form:

$$W = {W}_{1}^{PS} {\tilde{W}}_{2 , l} {W}_{f , l}^{H}$$

Here, \tilde{W}_{2,l} and W_{f,l} follow the same structure as the conventional NR Rel-16 Type-II Codebook, described above, where both are transmission layer specific. The matrix W₁^{PS} is a K×2L block-diagonal matrix with the same structure as that in the NR Rel-15 Type-II port selection codebook, described above.

The 3GPP NR Release 17 (Rel-17) Type-II port selection codebook follows a similar structure as that of Rel-15 and Rel-16 Type-II port selection codebooks, as follows:

$${W}_{l} = {\overline{W}}_{1}^{PS} {\tilde{W}}_{2 , l} {W}_{f , l}^{H} .$$

where the superscript ^{H} denotes a matrix Hermitian, i.e., conjugate transposition operator.

Here, \tilde{W}_{2,l} and W_{f,l} follow the same structure as the conventional NR Rel-16 Type-II Codebook; however M is limited to 1,2 only, with the network configuring a window of size N={2,4} for M=2. Moreover, the bitmap is reported unless β=1 and the UE reports all the coefficients for a rank up to a value of two.

However, unlike Rel-15 and Rel-16 Type-II port selection codebooks, the port-selection matrix W̅₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers.

The 3GPP NR Release 18 (Rel-18) Type-II codebook, the time-domain corresponding to slots is further compressed via DFT-based transformation, wherein the codebook is in the following form:

$${W}_{l} = {W}_{1} {{\tilde{W}}_{2 , l} ( {W}_{f , l} ⊗ {W}_{d , l} )}^{H}$$

where W₁, W_{f,l} follow the same structure as Rel-16 Type-II codebook, and where the superscript ^{H} denotes a matrix Hermitian, i.e., conjugate transposition operator.

The matrix W_{d,l} is an N₄×Q matrix (Q≤N₄) with columns selected from a critically-sampled size-N₄ DFT matrix, as follows:

$${W}_{d , l} = [ \begin{matrix}{d}_{{q}_{0}} & {d}_{{q}_{1}} & … & {d}_{{q}_{Q - 1}}\end{matrix} ] , 0 \leq {q}_{i} \leq {N}_{4} - 1 ,$$

$${d}_{q} = [ \begin{matrix}1 & {e}^{- j \frac{2 π q}{{N}_{4}}} & … & {e}^{- j \frac{2 π q ( {N}_{4} - 1 )}{{N}_{4}}}\end{matrix} ] .$$

Only the indices of the Q selected columns of W_{d,l} are reported. W_{d,l} may be layer specific, e.g., W_{d,1}≠W_{d,2}, or layer common, i.e., W_{d,1}=···=W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with the Rel-18 Type-II codebook.

Regarding codebook reporting, the CSI codebook report may be partitioned into two parts based on the priority of information reported. Each part may be encoded separately. Part 1 of the CSI codebook report may possibly have a higher code rate. Below is listed list the parameters for NR Rel-16 Type-II codebook only. More details can be found in 3GPP TS 38.214, Sections 5.2.3 and 5.2.4.

Regarding the contents of the CSI report, Part 1 of the CSI report comprises a RI, plus a CQI, plus the total number of coefficients (i.e., represented using a single value). Part 2 of the CSI report comprises an SD basis indicator, plus an FD basis indicator per layer, plus a bitmap per layer, plus coefficient amplitude information per layer, plus coefficient phase information per layer, plus a strongest coefficient indicator per layer.

Furthermore, Part 2 of the CSI report can be decomposed into sub-parts each with different priority (higher priority information listed first). Such partitioning is required to allow dynamic reporting size for codebook based on available resources in the uplink phase. More details can be found in 3GPP TS 38.214, Section 5.2.3.

Also Type-II codebook is based on aperiodic CSI reporting, and only reported in PUSCH via downlink control information (DCI) triggering (one exception). Type-I codebook can be based on periodic CSI reporting (i.e., using physical uplink control channel (PUCCH)) or semi-persistent (SP) CSI reporting (i.e., using PUSCH or PUCCH) or aperiodic (AP) reporting (i.e., using PUSCH).

Regarding Triggering aperiodic CSI reporting on PUSCH, the UE needs to report the needed CSI information for the network using the CSI framework in NR Release 15. The triggering mechanism between a CSI reporting setting and a resource setting can be summarized in Table 1 below:

TABLE 1
Triggering mechanism between a CSI reporting setting and a resource setting

| | | Periodic CSI | SP CSI | AP CSI |
|---|---|---|---|---|
| | | Reporting | Reporting | Reporting |
| Time Domain | Periodic | RRC configured | MAC CE (PUCCH) | DCI |
| Behavior of | CSI-RS | | DCI (PUSCH) | |
| Resource | SP CSI-RS | Not Supported | MAC CE (PUCCH) | DCI |
| Setting | | | DCI (PUSCH) | |
| | AP CSI-RS | Not Supported | Not Supported | DCI |

Moreover, all associated Resource Settings for a CSI reporting setting need to have same time domain behavior. Periodic CSI-RS resource and/or CSI-IM resource and CSI reports are always assumed to be present and active once configured by RRC. Aperiodic and semi-persistent CSI-RS resources and/or CSI-IM resources and CSI reports need to be explicitly triggered or activated. Aperiodic CSI-RS resources and/or CSI-IM resources and aperiodic CSI reports, the triggering is done jointly by transmitting a DCI Format 0-1. Semi-persistent CSI-RS resources and/or CSI-IM resources and semi-persistent CSI reports are independently activated.

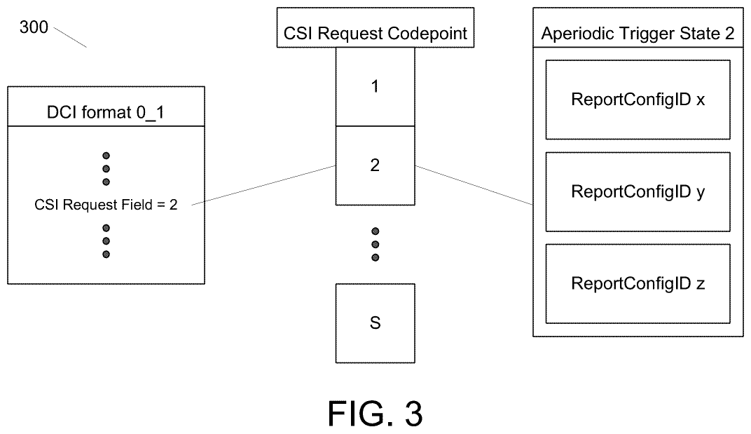

FIG. 3 depicts an exemplary scenario 300 of an aperiodic trigger state defining a list of CSI reporting settings, according to embodiments of the disclosure. For aperiodic CSI-RS resources and/or CSI-IM resources and aperiodic CSI reports, the triggering is done jointly by transmitting a DCI Format 0_1. The DCI Format 0_1 contains a CSI request field (0 to 6 bits). A non-zero request field points to a so-called aperiodic trigger state configured by RRC. An aperiodic trigger state in turn is defined as a list of up to 16 aperiodic CSI reporting setting s, identified by a CSI reporting setting ID for which the UE calculates simultaneously CSI and transmits it on the scheduled PUSCH transmission.

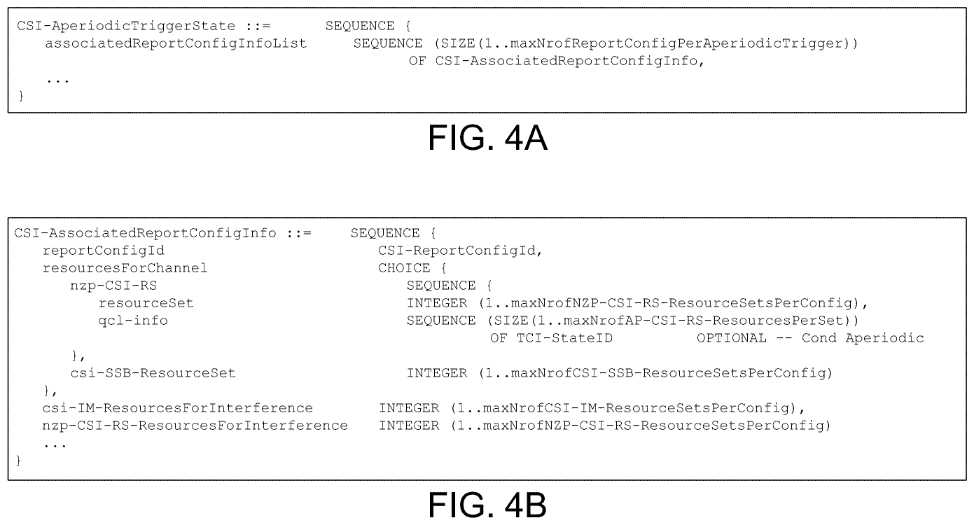

FIG. 4A depicts an exemplary ASN.1 structure of an aperiodic trigger state that indicates the resource set and QCL information, according to embodiments of the disclosure.

FIG. 4B depicts an exemplary ASN.1 structure of an associated CSI resource configuration, according to embodiments of the disclosure. One or more associated CSI resource configurations may be referenced by the aperiodic trigger state of FIG. 4A.

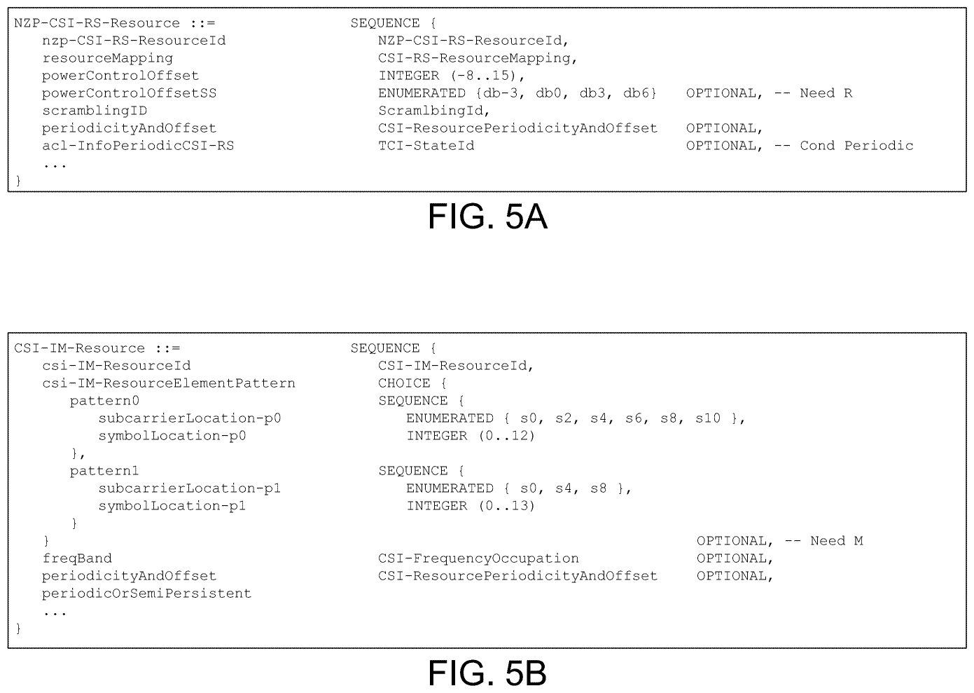

FIG. 5A depicts an exemplary ASN.1 structure of an RRC configuration for NZP CSI-RS resources, according to embodiments of the disclosure.

FIG. 5B depicts an exemplary ASN.1 structure of an RRC configuration for CSI-IM resources, according to embodiments of the disclosure.

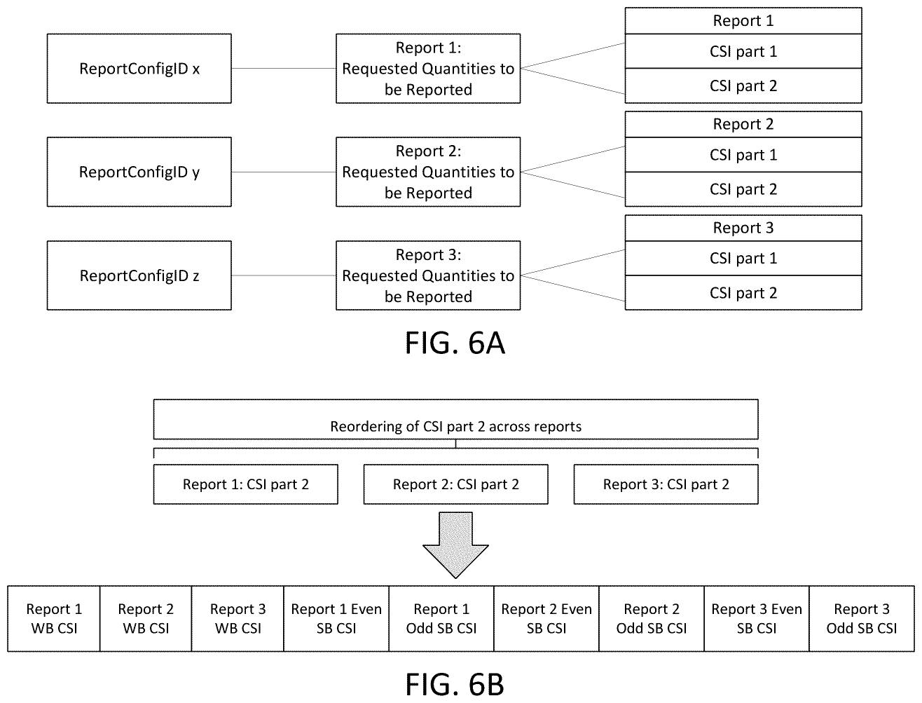

FIG. 6A illustrates an example of CSI report generation, in accordance with aspects of the present disclosure.

FIG. 6B illustrates an example of partial CSI omission and reordering for Physical Uplink Shared Channel (PUSCH) based CSI, in accordance with aspects of the present disclosure.

A UE may be configured with one or more CSI reporting setting (e.g., CSI-ReportConfig IE) that configures the UE with CSI measurement parameters. For example, the CSI measurement parameters indicated in the CSI reporting setting may include the resources for channel measurement (e.g., indicated using parameter resourcesForChannelMeasurement) and a CSI report quantity (e.g., indicated using parameter reportQuantity). Moreover, each CSI reporting setting is associated with an identifier (ID) (e.g., indicated using parameter reportConfigId). The CSI Reporting Setting is further configured with a including values from ‘none’, and other values including at least ‘PMI’.

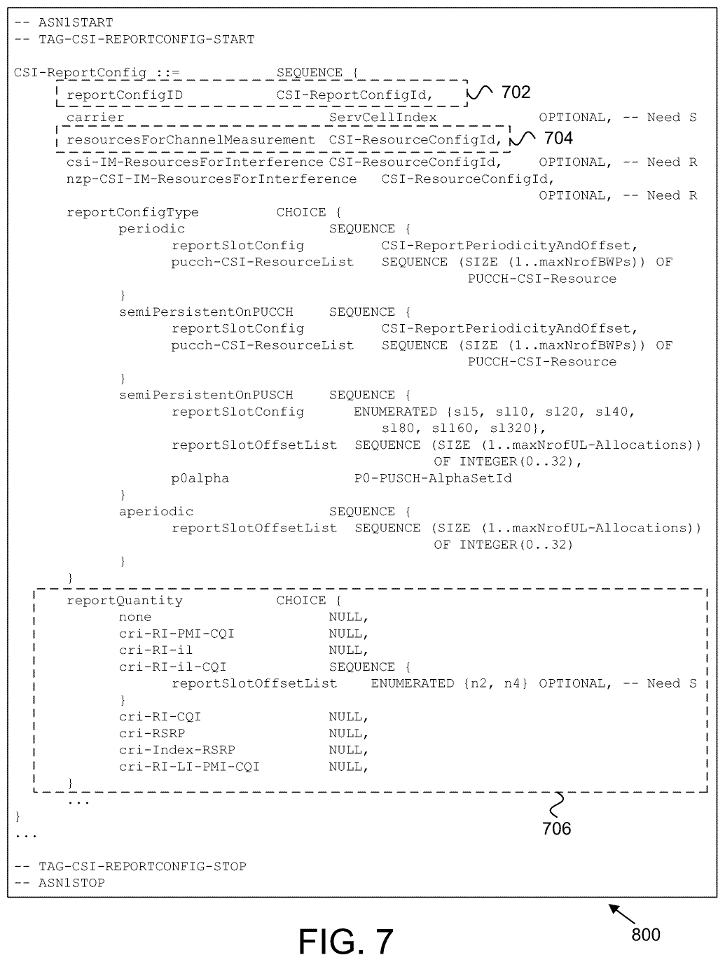

FIG. 7 illustrates an example of a CSI reporting setting IE 700 (e.g., CSI-ReportConfig IE), in accordance with aspects of the present disclosure. As noted herein, the network may transmit the CSI reporting setting IE 700 to a particular UE to configure that UE with resources for channel measurement and related parameters for CSI measurement. More specifically, the CSI reporting setting IE 700 includes at least a reportConfigId parameter 702 that associates the CSI reporting setting IE 700 with an ID, a resourcesForChannelMeasurement parameter 704 that configures the UE with CSI measurement based on resources for channel measurement, and a reportQuantity parameter 706 that configures the UE with a CSI report quantity, i.e., including values ‘none’ and other values including at least ‘PMI’.

Regarding Antenna Panel/Port, QCL, Transmission Configuration Indicator (TCI) state, and Spatial Relation, in some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its transmit (Tx) beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi-co-located (QCL-ed) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial receive (Rx) parameters. Two antenna ports may be QCL-ed with respect to a subset of the large-scale properties and different subset of large-scale properties may be indicated by a QCL Type parameter.

The QCL Type parameter can indicate which channel properties are the same between the two reference signals (e.g., on the two antenna ports). Thus, the reference signals can be linked to each other with respect to what the UE can assume about their channel statistics or QCL properties. For example, parameter qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Spatial Rx parameters may include one or more of: angle of arrival (AoA), Dominant AoA, average AoA, angular spread, Power Angular Spectrum (PAS) of AoA, average angle of departure (AoD), PAS of AoD, transmit/receive channel correlation, transmit/receive beamforming, spatial channel correlation etc.

The values QCL-TypeA, QCL-TypeB, and QCL-TypeC may be applicable for all carrier frequencies, but the value QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD parameter between two reference signals A and B, the reference signal A is considered to be spatially co-located with reference signal B and the UE may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI state associated with a target transmission can indicate parameters for configuring a QCL relationship between the target transmission (e.g., target reference signal (RS) of demodulation reference signal (DM-RS) ports of the target transmission during a transmission occasion) and a source reference signal(s) (e.g., synchronization signal block (SSB), CSI-RS, and/or sounding reference signal (SRS)) with respect to quasi co-location type parameter(s) indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

As described above, AI/ML tools may be employed to enhance CSI feedback and CSI prediction in wireless communications networks. To accommodate such use cases in high mobility scenarios (e.g., with UEs moving at high speeds) while maintaining similar quality of service, a modified CSI framework may be implemented that utilizes the enhanced Type-II CSI prediction codebook, which was initially designed for non-AI/ML techniques.

Regarding legacy CSI measurement and feedback, the UE 104 receives a CSI reporting setting (e.g., from the NE 102) comprising a CSI resource configuration. Based on the CSI measurement corresponding to the CSI resource configuration and the codebook configuration in the CSI reporting setting, the UE 102 generates a CSI codebook, such as a Rel-18 Type-II codebook described above.

However, the legacy CSI resource configuration spans a relatively small duration (i.e., time window) and does not provide sufficient data to train a CSI prediction model. Additionally, using the CSI measurements in the (small) time window to infer a non-AI based CSI prediction filter may not yield good performance. Accordingly, there is need for a modified CSI framework to accommodate the training needs of the CSI prediction model and the performance needs of the inferred CSI prediction filter.

Regarding legacy periodic and semi-persistent CSI-RS resource configuration for the data collection phase, during the data collection phase, the UE 104 may be configured with a channel measurement resource comprising one or more periodic or semi-persistent CSI-RS resources with arbitrary offset values in time. However, the training data for the AI/ML model does not match the configuration of the model input corresponding to the received CSI-RS for inference, leading to model imprecision.

Regarding legacy aperiodic CSI-RS resource configuration for the data collection phase, during the data collection phase, the UE is configured with a channel measurement resource comprising multiple aperiodic CSI-RS resources with arbitrary offset values in time. However, to enable sufficient training data collection for proper model training a large number of aperiodic CSI-RS resources need to be triggered.

The present disclosure describes techniques for robust AI/ML data collection for UE-sided model training, e.g., for CSI prediction purposes. According to a possible implementation, one or more elements or features from one or more of the described implementations may be combined.

In general, the CSI measurement and reporting is pursued over two phases: a first phase corresponding to data collection associated with CSI; followed by a second phase corresponding to a CSI inference phase based on a model trained the data collection in the first phase.

As used herein, the following terms are used interchangeably: network nodes, TRP, panel, set of antennas, set of antenna ports, uniform linear array, cell, node, radio head, communication (e.g., signals/channels) associated with a control resource set (CORESET) pool, communication associated with a TCI state from a transmission configuration comprising at least two TCI states.

As used herein, a TRS corresponds to an NZP CSI-RS resource set with a parameter ‘trs-info’ being configured. As used herein, a CSI-RS for beam management corresponds to an NZP CSI-RS resource set with a parameter ‘repetition’ being configured. As used herein, a CSI-RS for CSI corresponds to an NZP CSI-RS resource set with neither parameters ‘trs-info’ nor ‘repetition’ being configured.

As used herein, a matrix implies a sequence of fields of an arbitrary dimension, including an array (vector) of values, a standard 2D matrix and more generally a Q-dimensional matrix (tensor) wherein Q>2 is an integer value. Moreover, a mapping between a transport block and a codeword transmitted in DL can be based on a one-to-one mapping between the TBs and codewords.

According to aspects of the first solution, a UE may be configured with multiple, related CSI reporting settings corresponding to AI/ML model training phases or AI/ML model inference phases. In some implementations, the UE 104 is configured with a first CSI reporting setting (i.e., a first configuration CSI-ReportConfig IE) for the data collection phase. The first CSI reporting setting may be one implementation of the CSI reporting setting IE 700. The first CSI reporting setting is identified by a particular ID value.

In some implementations, the first CSI reporting setting includes the higher layer parameter N4 and also includes the parameter reportQuantity set to a first value, e.g., ‘none’, indicating that no CSI reporting is expected based on the first CSI-ReportConfig IE. Moreover, the first CSI reporting setting may configure the UE 104 with a first CSI-RS resource set for channel measurement.

In some implementations, the UE 104 is configured with K periodic CSI-RS resources or semi-persistent CSI-RS resources of the first CSI-RS resource set, e.g., K∈{4,8,12}. In such implementations, the K CSI-RS resources in the first CSI-RS resource set may be configured with K periodicity-and-offset values, including a distinct offset value across the CSI-RS resources and a same periodicity value across the CSI-RS resources, wherein the separation between two consecutive offset values is equal to m slots, e.g., where m is an integer value. In one implementation, the parameter K may be indicated in a configuration for channel measurement included in the first CSI-ReportConfig IE. In another implementation, the parameter m may be indicated in a configuration for channel measurement included in the first CSI-ReportConfig IE.

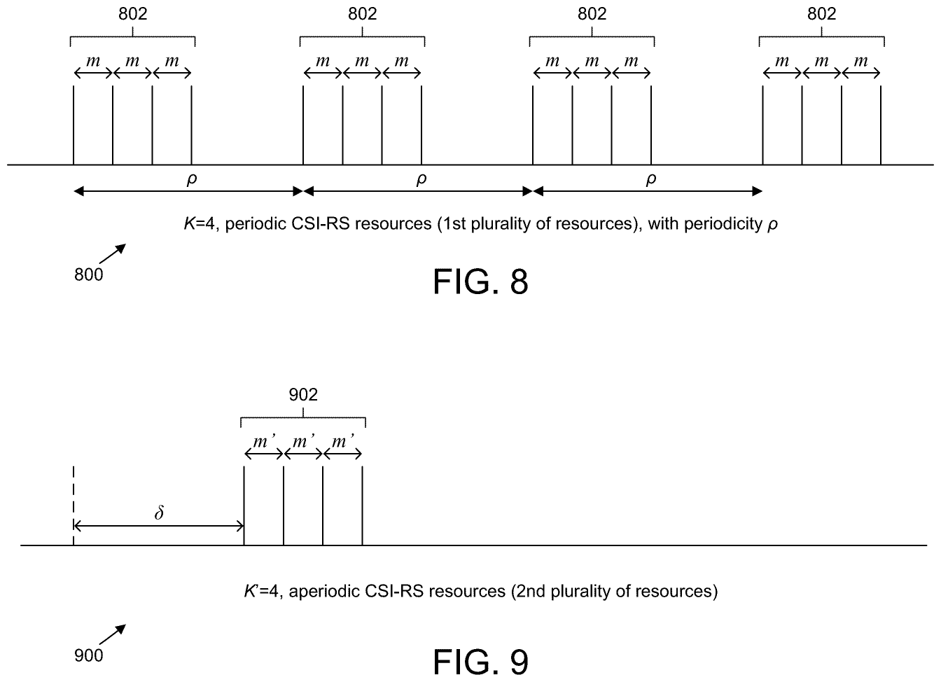

FIG. 8 illustrates an example of a signaling timeline 800 of CSI-RS for the data collection phase, in accordance with aspects of the present disclosure. The signaling timeline 800 may implement or be implemented by aspects of the wireless communication system 100. For example, the CSI-RS shown in the signaling timeline 800 may be transmitted between a base station, which may be an example of the NE 102, and a UE, which may be an example of the UE 104, as described herein.

The signaling timeline 800 depicts a set of K periodic CSI-RS 802 having a spacing (i.e., a separation between two consecutive offset values) equal to m slots and a periodicity with value ‘ρ’. In some implementations, the signaling timeline 800 may be indicated to the UE via a first CSI reporting setting (i.e., the first CSI-ReportConfig IE), which may be one implementation of the CSI reporting setting IE 700.

The UE may be further configured with a second CSI reporting setting (i.e., a second configuration CSI-ReportConfig IE) for the inference phase. The second CSI reporting setting may be one implementation of the CSI reporting setting IE 700. In some examples, the second CSI reporting setting includes the higher layer parameter N4 and also includes the parameter reportQuantity set to indicate a PMI associated with a codebook configuration. In one implementation, the parameter reportQuantity may be set to the value ‘cri-RI-PMI-CQI’. In another implementation, the parameter reportQuantity may be set to the value ‘cri-RI-LI-PMI-CQI’. Moreover, the second CSI reporting setting may configure the UE 104 with a second CSI-RS resource set for channel measurement.

In such implementations, the UE 104 is further configured with K′ aperiodic CSI-RS resources or semi-persistent CSI-RS resources of the second CSI-RS resource set for channel measurement, e.g., K′=K, where K∈{4,8,12}. In some examples, the K′CSI-RS resources are triggered by the same triggering message (e.g. DCI) and a separation between two consecutive CSI-RS resources is m′∈{1,2} slots, e.g., m′=m, which is configured by higher layer parameter in the NZP-CSI-RS-ResourceSet IE.

The second CSI reporting setting is identified by a first ID value. In some implementations, the second CSI reporting setting (i.e., second CSI-ReportConfig IE) may include a parameter indicating a second ID value corresponding to the first CSI reporting setting (i.e., first CSI-ReportConfig IE), where the ID value is associated with a CSI-ReportConfig IE corresponding to a training phase or data collection phase. In other words, a CSI reporting setting (i.e., CSI-ReportConfig IE) for channel inference may be associated with a CSI reporting setting for data collection, where the ID of the corresponding CSI reporting setting for data collection is included in the CSI reporting setting for channel inference.

FIG. 9 illustrates an example of a signaling timeline 900 of CSI-RS for the inference phase, in accordance with aspects of the present disclosure. The signaling timeline 900 may implement or be implemented by aspects of the wireless communication system 100. For example, the CSI-RS shown in the signaling timeline 900 may be transmitted between a base station, which may be an example of the NE 102, and a UE, which may be an example of the UE 104, as described herein.

The signaling timeline 900 depicts a set of K′ aperiodic CSI-RS 902 having a spacing (i.e., a separation between two consecutive offset values) equal to m′ slots. Additionally, the time-domain location of a first CSI-RS in the set of K′ aperiodic CSI-RS 902 may be an offset of ‘δ’ from a starting location of the first CSI-RS in the set of K periodic CSI-RS 802. In some implementations, the signaling timeline 900 may be indicated to the UE via a second CSI reporting setting (i.e., the second CSI-ReportConfig IE), which may be one implementation of the CSI reporting setting IE 700. The association between the set of K periodic CSI-RS 802 and the set of K′ aperiodic CSI-RS 902 may be indicated in the second CSI reporting setting.

While the above implementations, the second CSI-RS resource set corresponds to aperiodic CSI-RS resources, in another implementation the second CSI-RS resource set may instead correspond to periodic or semi-persistent CSI-RS resources. In some examples, the K′ CSI-RS resources in the second CSI-RS resource set may be all configured with a same periodicity value that is larger than m′. In some examples, the periodicity value is no less than a product of the value K′and the value m′.

In some implementations, K is a first integer multiple of K′, e.g., K=2×K′, and m′ is a second integer multiple of m, e.g., m′=2×m. The value of the first integer multiple and the value of the second integer multiple may be the same. In one implementation, the parameters K′ and/or m′ may be indicated in a configuration for channel measurement included in the second CSI-ReportConfig IE. In another implementation, second CSI-ReportConfig IE may indicate a relationship between the parameters K and/or m of the first CSI-ReportConfig IE and the parameters K′ and/or m′ of the second CSI-ReportConfig IE.

For example, the second CSI-ReportConfig IE may indicate that K′=K and/or that m′=m. As another example, the second CSI-ReportConfig IE may indicate the first and second integers when K is a first integer multiple of K′ and/or when m′ is a second integer multiple of m.

According to aspects of the second solution, the network may indicate QCL relationships across CSI-RS resources corresponding to the multiple, related CSI reporting settings, e.g., CSI-RS resources corresponding to the first CSI reporting setting and the second CSI reporting setting. The QCL relationship indication may be in a form of a rule, or a higher-layer configuration associated with at least one of the two CSI Reporting Settings, one of the two CSI-RS resource sets, or a combination thereof. For example, QCL relationship indication may be indicated in the first CSI-ReportConfig IE or the second CSI-ReportConfig IE.

In some implementations, K′=K, and the K CSI-RS resources in the first CSI-RS resource set are resource-wise quasi-co-located (QCLed) with the K′ CSI-RS resources in the second CSI-RS resource set. For example, the first CSI-RS resource in the first CSI-RS resource set may be QCLed with the first CSI-RS resource in the second CSI-RS resource set, the second CSI-RS resource in the first CSI-RS resource set is QCLed with the second CSI-RS resource in the second CSI-RS resource set, etc., and the last CSI-RS resource in the first CSI-RS resource set is QCLed with the last CSI-RS resource in the second CSI-RS resource set.

In other implementations, the K CSI-RS resources in the first CSI-RS resource set may be group-wise QCLed with the K′ CSI-RS resources in the second CSI-RS resource set. For example, assume that K is an integer multiple of K′, wherein a value of the integer multiple is λ. Accordingly, a first group of λ consecutive CSI-RS resources in the first CSI-RS resource set are QCLed with a first CSI-RS resource in the second CSI-RS resource set, a second group of λ consecutive CSI-RS resources in the first CSI-RS resource set are QCLed with a second CSI-RS resource in the second CSI-RS resource set, etc., and a last group of λ consecutive CSI-RS resources in the first CSI-RS resource set are QCLed with a last CSI-RS resource in the second CSI-RS resource set.

In one example, the QCL relationship corresponds to QCL Type-A and QCL Type-D, if applicable. In some implementations, the K CSI-RS resources in the first CSI-RS resource set are mutually QCLed, e.g., the QCL relationship corresponds to QCL Type-A and QCL Type-D, as applicable.

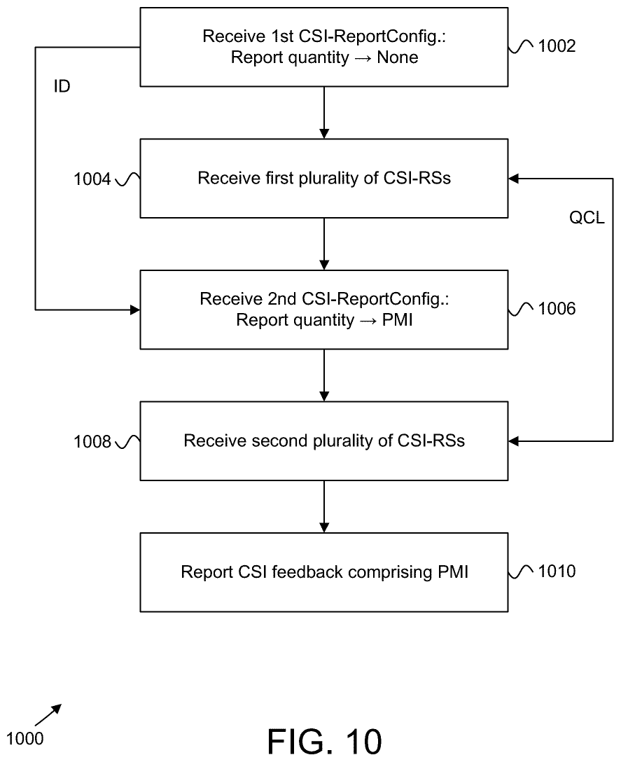

FIG. 10 illustrates an example of a procedure 1000 for configuring a UE with multiple CSI reporting settings for AI/ML training and inference, in accordance with aspects of the present disclosure. The procedure 1000 may implement or be implemented by aspects of the wireless communication system 100. For example, the procedure 1000 may be performed by a UE, which may be an example of the UE 104, as described herein.

The procedure 1000 begins and at step 1002, the UE receives (e.g., from the network) a first CSI reporting setting (e.g., first CSI-ReportConfig IE) with a report quantity indicating that no CSI reporting is expected. For example, the parameter reportQuantity may be set to the value ‘none’. Here, the first CSI reporting setting is identified using a first ID value.

At step 1004, the UE receives a first plurality of RSs, i.e., corresponding to the first CSI reporting setting.

At step 1006, the UE receives (e.g., from the network) a second CSI reporting setting (e.g., second CSI-ReportConfig IE) with a report quantity indicating that a report with PMI associated with a codebook configuration is expected. For example, the parameter reportQuantity may be set to the value ‘cri-RI-PMI-CQI’. Additionally, the second CSI reporting setting includes the first ID value associated with the first CSI reporting setting and also includes a second ID values identifying the second CSI reporting setting.

At step 1008, the UE receives a second plurality of RSs, i.e., corresponding to the second CSI reporting setting. Here, the second plurality of RSs are QCLed with the first plurality of RSs. In one embodiment, the QCL relationship is implicitly indicated when the second CSI reporting setting includes the first ID value associated with the first CSI reporting setting. In another embodiment, the QCL relationship may be defined (i.e., explicitly indicated) in the second CSI reporting setting.

At step 1010, the UE performs CSI measurement on at least the second plurality of RSs and reports (i.e., generates and transmits) CSI feedback comprising at least one PMI value based on a codebook configuration associated with the second CSI reporting setting.

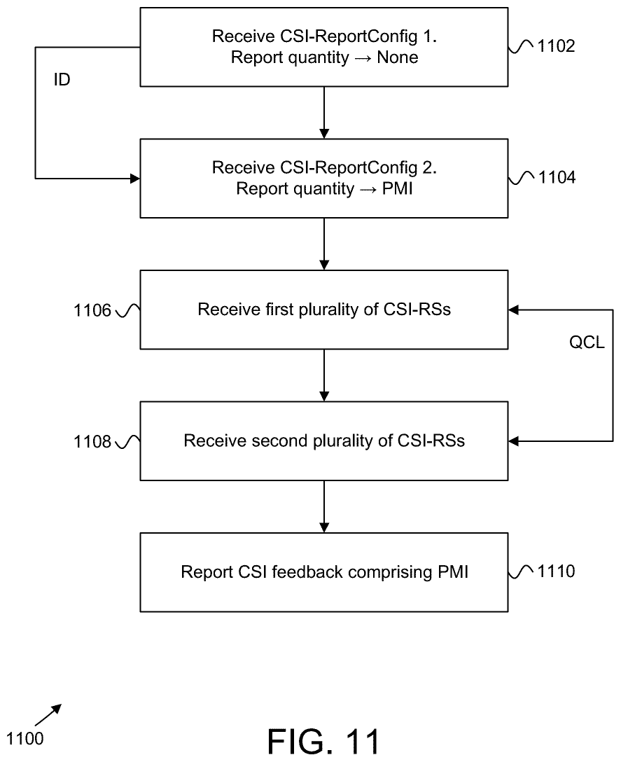

FIG. 11 illustrates an example of a procedure 1100 for configuring a UE with multiple CSI reporting settings for AI/ML training and inference, in accordance with aspects of the present disclosure. The procedure 1100 may implement or be implemented by aspects of the wireless communication system 100. For example, the procedure 1100 may be performed by a UE, which may be an example of the UE 104, as described herein.

The procedure 1100 is similar to the procedure 1000 described with reference to FIG. 10, with differences in when the second CSI reporting setting is received relative to the CSI-RS. The procedure 1100 begins and at step 1102, the UE receives a first CSI reporting setting with a report quantity indicating that no CSI reporting is expected; the first CSI reporting setting being identified using a first ID value.

At step 1104, the UE receives a second CSI reporting setting with a report quantity indicating that a report with PMI associated with a codebook configuration is expected. Additionally, the second CSI reporting setting includes the first ID value associated with the first CSI reporting setting and also includes a second ID values identifying the second CSI reporting setting.

In the depicted embodiment, the second CSI reporting is received after the first CSI reporting setting. However, in other embodiments the first CSI reporting setting and the second CSI reporting may be received at the same time.

At step 1106, the UE receives a first plurality of RSs, i.e., corresponding to the first CSI reporting setting. At step 1108, the UE receives a second plurality of RSs, i.e., corresponding to the second CSI reporting setting. Here, the second plurality of RSs are QCLed with the first plurality of RSs.

At step 1110, the UE performs CSI measurement on at least the second plurality of RSs and reports (i.e., generates and transmits) CSI feedback comprising at least one PMI value based on a codebook configuration associated with the second CSI reporting setting.

According to aspects of the third solution, a burst configuration of aperiodic CSI-RS resources for inference (e.g., associated with the second CSI reporting setting) may be matched (in the time-domain) with a configuration of multiple periodic CSI-RS resources for data collection.

In some implementations, the UE is configured with a first CSI reporting setting (e.g., first CSI-ReportConfig IE) with the higher layer parameter N4 and with the parameter reportQuantity set to ‘none’, wherein the UE is further configured with one or more (e.g., K) periodic CSI-RS resources (or semi-persistent CSI-RS resources) of a first CSI-RS resource set for channel measurement. In such implementations, the K CSI-RS resources in the first CSI-RS resource set may be configured with K periodicity-and-offset values, having a distinct offset value across the CSI-RS resources and a same periodicity value across the CSI-RS resources, wherein the separation between two consecutive offset values is equal to m slots, or is an integer fraction of m, e.g., m/2 slots.

In some implementations of the third solution, the K CSI-RS resources in the second CSI-RS resource set may be all configured with the same periodicity value ‘ρ’, where ρ>m. In some examples, the periodicity value is no less than a product of the value K and the value m (i.e., ρ>K×m). In some examples, the value of K=1. The first CSI reporting setting may be one implementation of the CSI reporting setting IE 700. The first CSI reporting setting is identified by a particular ID value.

The UE may be further configured with a second CSI reporting setting (e.g., second CSI-ReportConfig IE) with the higher layer parameter N4 and with the parameter reportQuantity set to ‘cri-RI-PMI-CQI’, wherein the UE is further configured with a periodic or semi-persistent CSI-RS resource in a second CSI-RS resource set for channel measurement with a periodicity value of m slots.

In certain implementations, each of the K CSI-RS resources in the first CSI-RS resource set is QCLed with the periodic or semi-persistent CSI-RS resource in the second CSI-RS resource set for channel measurement CSI-RS resources in the second CSI-RS resource set. In one example, the QCL relationship corresponds to QCL Type-A and QCL Type-D, if applicable.

In some examples, the K CSI-RS resources in the second CSI-RS resource set are mutually QCLed, e.g., the QCL relationship corresponds to QCL Type-A and QCL Type-D, if applicable.

The second CSI reporting setting is identified by a first ID value. In some implementations, the second CSI reporting setting (i.e., second CSI-ReportConfig IE) may include a parameter indicating a second ID value corresponding to the first CSI reporting setting (i.e., first CSI-ReportConfig IE), where the ID value is associated with a CSI-ReportConfig IE corresponding to a training phase or data collection phase.

According to aspects of the fourth solution, the network (e.g. an implementation of the NE 104) may signal the UE to release the trained model and/or collected dataset for CSI prediction (i.e., channel inference). In order to convey one or more AI/ML-based CSI predictions, the UE needs to maintain the collected CSI training dataset, the corresponding AI/ML CSI prediction model, or a combination thereof. After some period of time, the AI/ML-model may be deemed obsolete due to, e.g., change in environment, deteriorating performance observed during model monitoring, or the availability of a more reliable or fresher dataset for training.

Accordingly, the UE and the network may need to communicate to each other that the collected CSI training dataset, the corresponding AI/ML CSI prediction model, or both, have been released, to avoid situations where the UE keeps storing the CSI training dataset, or the corresponding AI/ML CSI prediction model unnecessarily, even when the network is not expected to configure the UE with using the same model.

Alternatively, the UE and the network may need to communicate with each other to avoid scenarios wherein the network configures the UE with CSI reporting based on the AI/ML model if the UE had released (e.g., deleted) the corresponding CSI training dataset or the AI/ML CSI prediction model parameters from its stored memory. Several implementations are provided below. Moreover, a combination of one or more of the following implementations may be realized.

In a first implementation of the fourth solution, the network may configure the UE to release the CSI training dataset or the corresponding AI/ML CSI prediction model parameters from the UE memory based on a configured time threshold according to a rule. In other words, the model release at the UE may be based on a configured time threshold.

As a first example of this implementation, the configured time threshold is calculated from a time of receiving the second configuration. As a second example of this implementation, the configured time threshold is calculated from the time of receiving a last CSI-RS based on the second CSI resource configuration.

In a second implementation of the fourth solution, the network may configure the UE to release the CSI training dataset or the corresponding AI/ML CSI prediction model parameters from the UE memory based on a signal indicated from the network side. In other words, the model release at the UE may be based on network-initiated signaling.

As a first example of this implementation, the signal is a RRC release message received at the UE. As a second example of this implementation, the signal is a third configuration corresponding to a third CSI reporting setting associated with a new training phase, data collection phase, or a combination thereof.

In a third implementation of the fourth solution, the network may configure the UE to release the CSI training dataset or the corresponding AI/ML CSI prediction model parameters from the UE memory based on a signal indicated from the UE side. In other words, the model release at the UE may be based on UE-initiated signaling.

As a first example, the signal is a UE capability signal indicating a maximum period, a minimum period, or a combination thereof, over which the CSI training dataset or the corresponding AI/ML CSI prediction model parameters are expected to be stored in the UE device memory. As a second example, the signal is a feedback parameter, e.g., a CSI feedback parameter in a CSI report, an AI/ML monitoring report, or a combination thereof.

In a fourth implementation of the fourth solution, the network may configure the UE to release the CSI training dataset or the corresponding AI/ML CSI prediction model parameters from the UE memory based on a defined event. In other words, the model release at the UE may be based on a defined triggering event.

In a first example of this implementation, the defined event is a corresponding AI/ML monitoring output indicating a degraded performance of the AI/ML CSI prediction model. In a second example of this implementation, the defined event is a corresponding CSI feedback parameter value indicating a degraded channel quality, e.g., CQI value.

In a third example of this implementation, the defined event is a change in a corresponding CSI report configuration parameter corresponding to a bandwidth part, a frequency domain parameter, a spatial domain parameter, or some combination thereof. In a fourth example of this implementation, the event is associated with a handover or mobility procedure, a new C-RNTI associated to the UE, or some combination thereof.

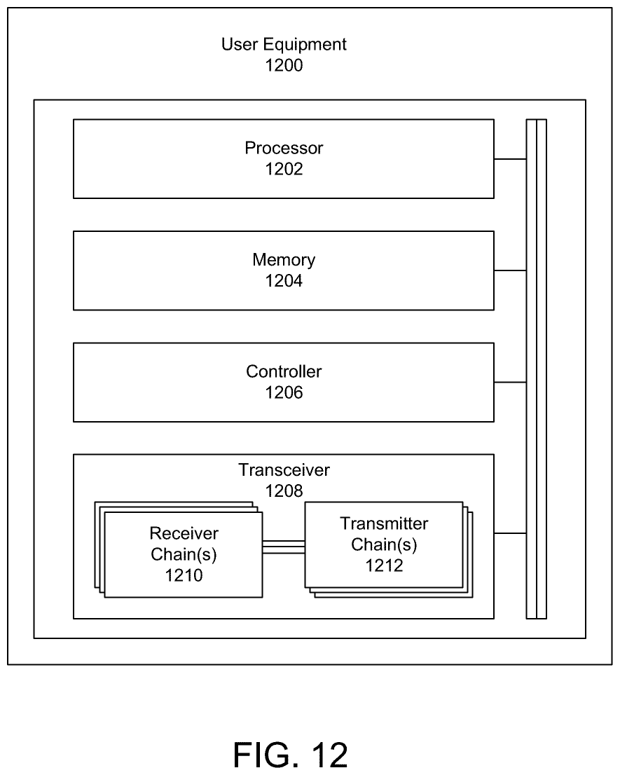

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a central processing unit (CPU), an ASIC, a field programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions that, when executed by the processor 1202, cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform various functions (e.g., operations, signaling) described herein (e.g., executing, by the processor 1202, instructions stored in the memory 1204). In some implementations, the processor 1202 may include multiple processors and the memory 1204 may include multiple memories. One or more of the multiple processors may be coupled with one or more of the multiple memories, which may be individually or collectively, configured to perform various functions (e.g., operations, signaling) of the UE 1200 as described herein.

In some implementations, the processor 1202 and the memory 1204 coupled with the processor 1202 may be configured to cause the UE 1200 to perform various functions (e.g., operations, signaling) of a first wireless node. For example, the processor 1202 coupled with the memory 1204 may be configured to, capable of, or operable to cause the UE 1200 to receive, from a network node, a first configuration associated with a first CSI reporting setting comprising: a first report quantity corresponding to a first value, and a first CSI resource configuration associated with a first set of channel measurement resources; receive, from the network node, a second configuration associated with a second CSI reporting setting comprising: a second report quantity comprising at least a PMI value associated with a codebook configuration, a second CSI resource configuration associated with a second set of channel measurement resources, and an identifier of the first configuration; perform a CSI measurement based on the first CSI resource configuration and the second CSI resource configuration, where the first configuration is received no later than the second configuration; generate a CSI report based on performing the CSI measurement; and transmit, to the network node, the CSI report comprising one or more PMI values based on the codebook configuration.

In some implementations, the first set of channel measurement resources corresponds to a first plurality of CSI-RS resources associated with one of periodic or semi-persistent time-domain behavior. In some implementations, the second set of channel measurement resources corresponds to a second plurality of CSI-RS resources associated with an aperiodic time-domain behavior. In such implementations, an offset in time between two consecutive CSI-RS resources received at the UE is in an order of one or more symbols, one or more slots, or a combination thereof.

In certain implementations, each CSI-RS resource in the first plurality of CSI-RS resources is associated with a periodicity value and a time offset value. In such implementations, the plurality of periodicity values of the first plurality of the CSI-RS resources have the same periodicity value. In certain implementations, a difference in offset values between two consecutive CSI-RS resources in the first plurality of CSI-RS resources is fixed.

In some implementations, the difference in offset values between the two consecutive CSI-RS resources in the first plurality of CSI-RS resources is equal to a value of the offset in time between two consecutive CSI-RS resources in the second plurality of CSI-RS resources.

In some implementations, the same periodicity value is larger than the value of the offset in time between two consecutive CSI-RS resources in the second plurality of CSI-RS resources. In certain implementations, the same periodicity value is equal to a product of the offset in time between two consecutive CSI-RS resources in the second plurality of CSI-RS resources, and a number of the CSI-RS resources in the first plurality of the CSI-RS resources.

In some implementations, a number of CSI-RS resources in the second plurality of CSI-RS resources is equal to a number of CSI-RS resources in the first plurality of CSI-RS resources. In certain implementations, CSI-RS resources in the first plurality of CSI-RS resources are resource-wise QCLed with CSI-RS resources in the second plurality of CSI-RS resources.

In certain implementations, the first plurality of CSI-RS resources and second plurality of CSI-RS resources are QCLed with respect to Doppler shift, Doppler spread, average delay and delay spread. In certain implementations, the first plurality of CSI-RS resources and second plurality of CSI-RS resources are QCLed with respect to a spatial receive parameter.

In some implementations, a channel (i.e., radio channel) corresponding to the CSI codebook is associated with a large Doppler value (i.e., where the Doppler spread and/or Doppler shift exceeds a threshold value). In such implementations, the CSI codebook may include a set of one or more PMI values, where each PMI value in the set of PMI values may correspond to a distinct time corresponding to a slot index or a symbol index.

In some implementations, the first configuration corresponds to a training period or a data collection phase, and where the first value indicates no reporting based on the first configuration.

In certain implementations, the processor 1202 coupled with the memory 1204 may be configured to cause the UE 1200 to release a CSI measurement associated with the first configuration based on: A) a first configured time threshold calculated from a time of receiving the first configuration; B) a second configured time threshold calculated from a time of receiving a last CSI-RS associated with the first CSI resource configuration; C) an RRC release message received at the UE; or some combination thereof.

The controller 1206 may manage input and output signals for the UE 1200. The controller 1206 may also manage peripherals not integrated into the UE 1200. In some implementations, the controller 1206 may utilize an operating system (OS) such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding/processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

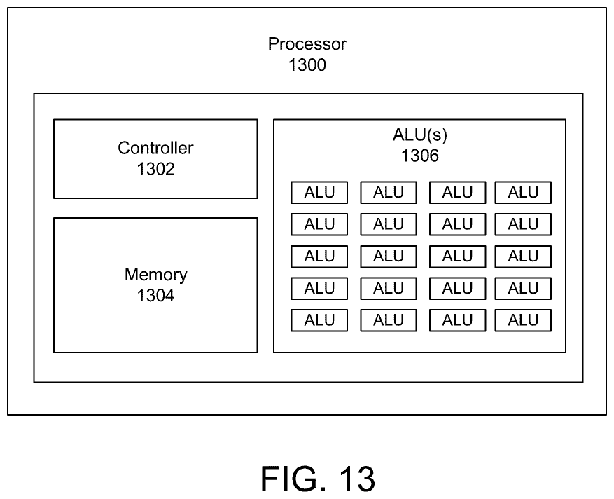

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1, or L2, or L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

In some implementations, the processor 1300 may support various functions (e.g., operations, signaling) of a UE, in accordance with examples as disclosed herein. For example, the controller 1302 coupled with the memory 1304 may be configured to, capable of, or operable to cause the processor 1300 to receive, from a network node, a first configuration associated with a first CSI reporting setting including: a first report quantity corresponding to a first value, and a first CSI resource configuration associated with a first set of channel measurement resources; receive, from the network node, a second configuration associated with a second CSI reporting setting including: a second report quantity containing at least a PMI value associated with a codebook configuration, a second CSI resource configuration associated with a second set of channel measurement resources, and an identifier of the first configuration; perform a CSI measurement based on the first CSI resource configuration and the second CSI resource configuration, where the first configuration is received no later than the second configuration; generate a CSI report based on performing the CSI measurement; and transmit, to the network node, the CSI report including one or more PMI values based on the codebook configuration. Additionally, the controller 1302 coupled with the memory 1304 may be configured to, capable of, or operable to cause the processor 1300 to perform one or more functions (e.g., operations, signaling) of the UE as described herein.

Additionally, or alternatively, in some other implementations, the processor 1300 may support various functions (e.g., operations, signaling) of a base station, in accordance with examples as disclosed herein. For example, the controller 1302 coupled with the memory 1304 may be configured to, capable of, or operable to cause the processor 1300 to transmit, to a UE, a first configuration associated with a first CSI reporting setting including: a first report quantity corresponding to a first value, and a first CSI resource configuration associated with a first set of channel measurement resources; transmit, to the UE, a second configuration associated with a second CSI reporting setting including: a second report quantity containing at least a PMI value associated with a codebook configuration, a second CSI resource configuration associated with a second set of channel measurement resources, and an identifier of the first configuration; transmit a set of CSI-RS associated with the first CSI resource configuration or the second CSI resource configuration, or both, where the first configuration is transmitted no later than the second configuration; and receive a CSI report from the UE, the CSI report including one or more PMI values based on the codebook configuration, the first configuration, and the second configuration. Additionally, the controller 1302 coupled with the memory 1304 may be configured to, capable of, or operable to cause the processor 1300 to perform one or more functions (e.g., operations, signaling) of the base station as described herein.

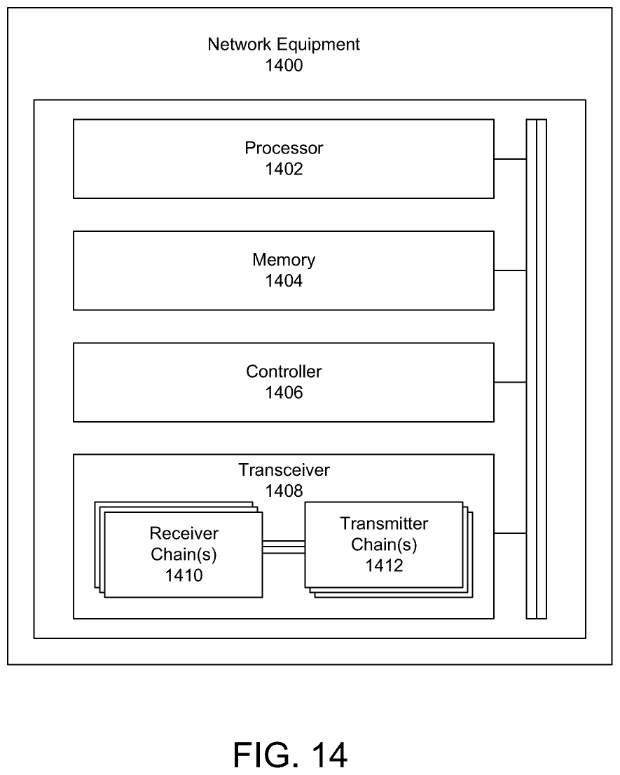

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform various functions (e.g., operations, signaling) described herein (e.g., executing, by the processor 1402, instructions stored in the memory 1404). In some implementations, the processor 1402 may include multiple processors and the memory 1404 may include multiple memories. One or more of the multiple processors may be coupled with one or more of the multiple memories, which may be individually or collectively, configured to perform various functions (e.g., operations, signaling) of the NE 1400 as described herein.

In some implementations, the processor 1402 and the memory 1404 coupled with the processor 1402 may be configured to cause the NE 1400 to perform various functions (e.g., operations, signaling) of a first wireless node. For example, the processor 1402 coupled with the memory 1404 may be configured to, capable of, or operable to cause the NE 1400 to transmit, to a UE, a first configuration associated with a first CSI reporting setting including: a first report quantity corresponding to a first value, and a first CSI resource configuration associated with a first set of channel measurement resources; transmit, to the UE, a second configuration associated with a second CSI reporting setting including: a second report quantity containing at least a PMI value associated with a codebook configuration, a second CSI resource configuration associated with a second set of channel measurement resources, and an identifier of the first configuration; transmit a set of CSI-RS associated with the first CSI resource configuration or the second CSI resource configuration, or both, where the first configuration is transmitted no later than the second configuration; and receive a CSI report from the UE, the CSI report including one or more PMI values based on the codebook configuration, the first configuration, and the second configuration.

In some implementations, the first set of channel measurement resources corresponds to a first plurality of CSI-RS resources associated with one of periodic or semi-persistent time-domain behavior. In some implementations, the second set of channel measurement resources corresponds to a second plurality of CSI-RS resources associated with an aperiodic time-domain behavior. In such implementations, an offset in time between two consecutive CSI-RS resources received at the UE is in an order of one or more symbols, one or more slots, or a combination thereof.

In certain implementations, each CSI-RS resource in the first plurality of CSI-RS resources is associated with a periodicity value and a time offset value. In such implementations, the plurality of periodicity values of the first plurality of the CSI-RS resources has the same periodicity value. In certain implementations, a difference in offset values between two consecutive CSI-RS resources in the first plurality of CSI-RS resources is fixed.

In some implementations, the difference in offset values between the two consecutive CSI-RS resources in the first plurality of CSI-RS resources is equal to a value of the offset in time between two consecutive CSI-RS resources in the second plurality of CSI-RS resources.

In some implementations, the same periodicity value is larger than the value of the offset in time between two consecutive CSI-RS resources in the second plurality of CSI-RS resources. In certain implementations, the same periodicity value is equal to a product of the offset in time between two consecutive CSI-RS resources in the second plurality of CSI-RS resources, and a number of the CSI-RS resources in the first plurality of the CSI-RS resources.

In some implementations, the number of CSI-RS resources in the second plurality of CSI-RS resources is equal to a number of CSI-RS resources in the first plurality of CSI-RS resources. In certain implementations, CSI-RS resources in the first plurality of CSI-RS resources are resource-wise QCLed with CSI-RS resources in the second plurality of CSI-RS resources.

In certain implementations, the first plurality of CSI-RS resources and second plurality of CSI-RS resources are QCLed with respect to Doppler shift, Doppler spread, average delay and delay spread. In certain implementations, the first plurality of CSI-RS resources and second plurality of CSI-RS resources are QCLed with respect to a spatial receive parameter.

In some implementations, a channel (i.e., radio channel) corresponding to the CSI codebook is associated with a large Doppler value (i.e., where the Doppler spread and/or Doppler shift exceeds a threshold value). In such implementations, the CSI codebook may include a set of one or more PMI values, where each PMI value in the set of PMI values may correspond to a distinct time corresponding to a slot index or a symbol index.

In some implementations, the first configuration corresponds to a training period or a data collection phase, and where the first value indicates no reporting based on the first configuration.

In certain implementations, the processor 1402 coupled with the memory 1404 may be configured to cause the NE 1400 to indicate, to the UE, to release a CSI measurement associated with the first configuration based on: A) a first configured time threshold calculated from a time of receiving the first configuration; B) a second configured time threshold calculated from a time of receiving a last CSI-RS associated with the first CSI resource configuration; C) an RRC release message transmitted to the UE; or some combination thereof.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding/processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

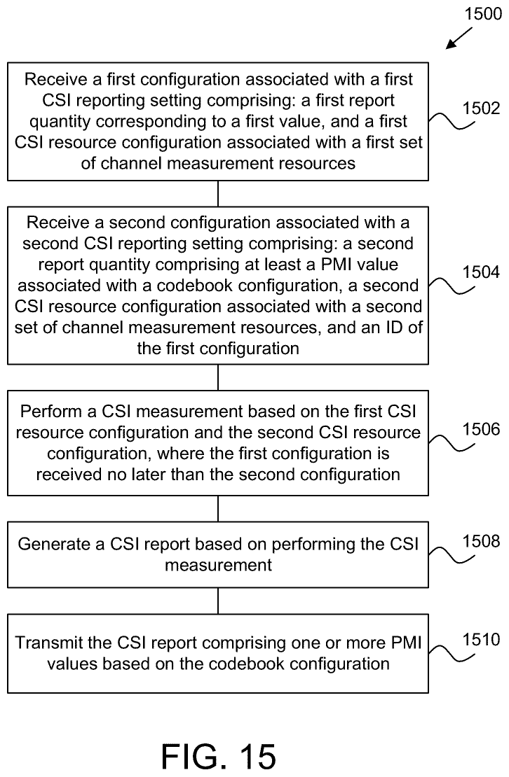

FIG. 15 illustrates a flowchart of a method 1500 in accordance with aspects of the present disclosure. The operations of the method 1500 may be implemented by a first wireless node as described herein. In some examples, the first wireless node may be implemented by a UE as described herein. In some implementations, the UE may execute a set of instructions to control the function elements of the UE to perform the described functions.

At step 1502, the method 1500 may include receiving, from a network node, a first configuration associated with a first CSI reporting setting containing at least: a first report quantity corresponding to a first value, and a first CSI resource configuration associated with a first set of channel measurement resources. The operations of step 1502 may be performed in accordance with examples as described herein. In some implementations, aspects of the operations of step 1502 may be performed by a UE, as described with reference to FIG. 12.

At step 1504, the method 1500 may include receiving, from the network node, a second configuration associated with a second CSI reporting setting containing at least: a second report quantity including at least a PMI value associated with a codebook configuration, a second CSI resource configuration associated with a second set of channel measurement resources, and an identifier of the first configuration. The operations of step 1504 may be performed in accordance with examples as described herein. In some implementations, aspects of the operations of step 1504 may be performed by a UE, as described with reference to FIG. 12.

At step 1506, the method 1500 may include performing a CSI measurement based on the first CSI resource configuration and the second CSI resource configuration, where the first configuration is received no later than the second configuration. The operations of step 1506 may be performed in accordance with examples as described herein. In some implementations, aspects of the operations of step 1506 may be performed by a UE, as described with reference to FIG. 12.

At step 1508, the method 1500 may include generating a CSI report based on performing the CSI measurement. The operations of step 1508 may be performed in accordance with examples as described herein. In some implementations, aspects of the operations of step 1508 may be performed by a UE, as described with reference to FIG. 12.

At step 1510, the method 1500 may include transmitting, to the network node, the CSI report including one or more PMI values based on the codebook configuration. The operations of step 1510 may be performed in accordance with examples as described herein. In some implementations, aspects of the operations of step 1510 may be performed by a UE, as described with reference to FIG. 12.

It should be noted that the method 1500 described herein describes one possible implementation, and that the operations and the steps may be rearranged or otherwise modified and that other implementations are possible.

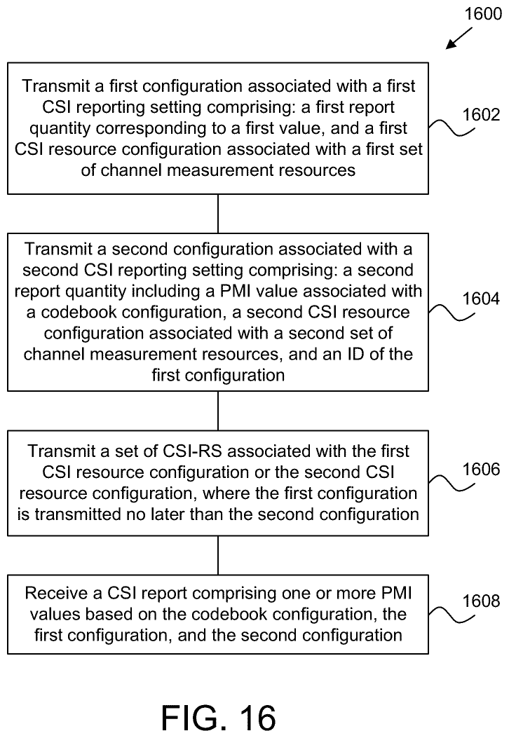

FIG. 16 illustrates a flowchart of a method 1600 in accordance with aspects of the present disclosure. The operations of the method 1600 may be implemented by a second wireless node as described herein. In some examples, the second wireless node may be implemented by a UE as described herein. Alternatively, the operations of the second wireless node may be implemented by a NE as described herein. In some implementations, the UE and/or NE may execute a set of instructions to control the function elements of the UE and/or NE to perform the described functions.

At step 1602, the method 1600 may include transmitting, to a UE, a first configuration associated with a first CSI reporting setting containing at least: a first report quantity corresponding to a first value, and a first CSI resource configuration associated with a first set of channel measurement resources. The operations of step 1602 may be performed in accordance with examples as described herein. In some implementations, aspects of the operations of step 1602 may be performed by a NE, as described with reference to FIG. 14.

At step 1604, the method 1600 may include transmitting, to the UE, a second configuration associated with a second CSI reporting setting containing at least: a second report quantity including at least a PMI value associated with a codebook configuration, a second CSI resource configuration associated with a second set of channel measurement resources, and an identifier of the first configuration. The operations of step 1604 may be performed in accordance with examples as described herein. In some implementations, aspects of the operations of step 1604 may be performed by a NE, as described with reference to FIG. 14.

At step 1606, the method 1600 may include transmitting a set of CSI-RS associated with the first CSI resource configuration or the second CSI resource configuration, or both, where the first configuration is transmitted no later than the second configuration. The operations of step 1606 may be performed in accordance with examples as described herein. In some implementations, aspects of the operations of step 1606 may be performed by a NE, as described with reference to FIG. 14.

At step 1608, the method 1600 may include receiving a CSI report from the UE, the CSI report including one or more PMI values based on the codebook configuration, the first configuration, and the second configuration. The operations of step 1608 may be performed in accordance with examples as described herein. In some implementations, aspects of the operations of step 1604 may be performed by a NE, as described with reference to FIG. 14.

It should be noted that the method 1600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network node, a first configuration associated with a first channel state information (CSI) reporting setting comprising:
a first report quantity corresponding to a first value, and
a first CSI resource configuration associated with a first set of channel measurement resources;
receive, from the network node, a second configuration associated with a second CSI reporting setting comprising:
a second report quantity comprising at least a precoding matrix indicator (PMI) value associated with a codebook configuration,
a second CSI resource configuration associated with a second set of channel measurement resources, and
an identifier of the first configuration;
perform a CSI measurement based on the first CSI resource configuration and the second CSI resource configuration, wherein the first configuration is received no later than the second configuration;
generate a CSI report based on performing the CSI measurement; and
transmit, to the network node, the CSI report comprising one or more PMI values based on the codebook configuration.

2. The UE of claim 1, wherein the first set of channel measurement resources corresponds to a first plurality of CSI reference signal (CSI-RS) resources associated with one of periodic or semi-persistent time-domain behavior.

3. The UE of claim 2, wherein the second set of channel measurement resources corresponds to a second plurality of CSI-RS resources associated with an aperiodic time-domain behavior, and wherein an offset in time between two consecutive CSI-RS resources received at the UE is in an order of one or more symbols, one or more slots, or a combination thereof.

4. The UE of claim 3, wherein each CSI-RS resource in the first plurality of CSI-RS resources is associated with a periodicity value and a time offset value, wherein the plurality of periodicity values of the first plurality of the CSI-RS resources have a same periodicity value, and wherein a difference in offset values between two consecutive CSI-RS resources in the first plurality of CSI-RS resources is fixed.

5. The UE of claim 4, wherein the difference in offset values between the two consecutive CSI-RS resources in the first plurality of CSI-RS resources is equal to a value of the offset in time between two consecutive CSI-RS resources in the second plurality of CSI-RS resources.

6. The UE of claim 4, wherein the same periodicity value is larger than a value of the offset in time between two consecutive CSI-RS resources in the second plurality of CSI-RS resources.

7. The UE of claim 6, wherein the same periodicity value is equal to a product of the offset in time between two consecutive CSI-RS resources in the second plurality of CSI-RS resources, and a number of the CSI-RS resources in the first plurality of the CSI-RS resources.

8. The UE of claim 4, wherein a number of CSI-RS resources in the second plurality of CSI-RS resources is equal to a number of CSI-RS resources in the first plurality of CSI-RS resources.

9. The UE of claim 8, wherein CSI-RS resources in the first plurality of CSI-RS resources are resource-wise quasi-co-located with CSI-RS resources in the second plurality of CSI-RS resources.

10. The UE of claim 9, wherein the first plurality of CSI-RS resources and second plurality of CSI-RS resources are quasi-co-located with respect to Doppler shift, Doppler spread, average delay and delay spread.

11. The UE of claim 9, wherein the first plurality of CSI-RS resources and second plurality of CSI-RS resources are quasi-co-located with respect to a spatial receive parameter.

12. The UE of claim 1, wherein a channel corresponding to the CSI codebook is associated with a large Doppler value, and wherein the CSI codebook comprises a set of PMI values, and where each PMI value in the set of PMI values corresponds to a distinct time corresponding to a slot index or a symbol index.

13. The UE of claim 1, wherein the first configuration corresponds to a training period or a data collection phase, and wherein the first value indicates no reporting based on the first configuration.

14. The UE of claim 13, wherein the at least one processor is configured to cause the UE to release a CSI measurement associated with the first configuration based on:
a first configured time threshold calculated from a time of receiving the first configuration;
a second configured time threshold calculated from a time of receiving a last CSI reference signal (CSI-RS) associated with the first CSI resource configuration;
a Radio Resource Control (RRC) release message received at the UE; or
a combination thereof.

15. A method performed by a user equipment (UE), the method comprising:
receiving, from a network node, a first configuration associated with a first channel state information (CSI) reporting setting comprising:
a first report quantity corresponding to a first value, and
a first CSI resource configuration associated with a first set of channel measurement resources;
receiving, from the network node, a second configuration associated with a second CSI reporting setting comprising:
a second report quantity comprising at least a precoding matrix indicator (PMI) value associated with a codebook configuration,
a second CSI resource configuration associated with a second set of channel measurement resources, and
an identifier of the first configuration;
performing a CSI measurement based on the first CSI resource configuration and the second CSI resource configuration, wherein the first configuration is received no later than the second configuration;
generating a CSI report based on performing the CSI measurement; and
transmitting, to the network node, the CSI report comprising one or more PMI values based on the codebook configuration.

16. A base station for wireless communication, comprising:
at least one memory; and
at least one processor coupled with the at least one memory and configured to cause the base station to:
transmit, to a user equipment (UE), a first configuration associated with a first channel state information (CSI) reporting setting comprising:
a first report quantity corresponding to a first value; and
a first CSI resource configuration associated with a first set of channel measurement resources;
transmit, to the UE, a second configuration associated with a second CSI reporting setting comprising:
a second report quantity comprising at least a precoding matrix indicator (PMI) value associated with a codebook configuration,
a second CSI resource configuration associated with a second set of channel measurement resources, and
an identifier of the first configuration;
transmit a set of CSI reference signals (CSI-RS) associated with the first CSI resource configuration or the second CSI resource configuration, or both, wherein the first configuration is transmitted no later than the second configuration; and
receive a CSI report from the UE, the CSI report comprising one or more PMI values based on the codebook configuration, the first configuration, and the second configuration.

17. The base station of claim 16, wherein the first set of channel measurement resources corresponds to a first plurality of CSI-RS resources associated with one of periodic or semi-persistent time-domain behavior, and wherein the second set of channel measurement resources corresponds to a second plurality of CSI-RS resources associated with an aperiodic time-domain behavior, and wherein an offset in time between two consecutive CSI-RS resources received at the UE is in an order of one or more symbols, one or more slots, or a combination thereof.

18. The base station of claim 17, wherein each CSI-RS resource in the first plurality of CSI-RS resources is associated with a periodicity value and a time offset value, wherein the plurality of periodicity values of the first plurality of the CSI-RS resources have a same periodicity value, and wherein a difference in offset values between two consecutive CSI-RS resources in the first plurality of CSI-RS resources is fixed.

19. The base station of claim 16, wherein the first configuration corresponds to a training period or a data collection phase, and wherein the first value indicates no reporting based on the first configuration.

20. A method performed by a base station, the method comprising:
transmitting, to a user equipment (UE), a first configuration associated with a first channel state information (CSI) reporting setting comprising:
a first report quantity corresponding to a first value; and
a first CSI resource configuration associated with a first set of channel measurement resources;
transmitting, to the UE, a second configuration associated with a second CSI reporting setting comprising:
a second report quantity comprising at least a precoding matrix indicator (PMI) value associated with a codebook configuration,
a second CSI resource configuration associated with a second set of channel measurement resources, and
an identifier of the first configuration;
transmitting a set of CSI reference signal (CSI-RS), wherein the set of CSI-RS is associated with the first CSI resource configuration or the second CSI resource configuration, or both, wherein the first configuration is transmitted no later than the second configuration; and
receiving a CSI report from the UE, the CSI report comprising one or more PMI values based on the codebook configuration, the first configuration, and the second configuration.
